(19) United States
(12) Patent Application Publication
(10) Pub. No.: US 2008/0197613 A1
(43) Pub. Date: Aug. 21, 2008

(54) Rollover protection system for motor vehicles with a sensor-controlled actively deployable rollover body

(75) Inventor: Holger Latussek, Bergneustadt (DE)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Automotive Group ISE Innomotive Systems, Bergneustadt (DE)

(21) Appl. No.: 12/069,703

(22) Filed: Feb. 12, 2008

(30) Foreign Application Priority Data
Feb. 12, 2007 (DE) 10 2007 006 768.4

(51) Int. Cl. B60R 21/13

(52) U.S. Cl. 280/756

(57) ABSTRACT

The invention is based on a known rollover protection system for motor vehicles with a rollover body that is held guided in a holder affixed to the vehicle, a drive under spring tension for sensor-controlled deployment of the rollover body from a resting position to a protective position, and a locking device for the rollover body when deployed in the protective position. In order to create a very simple, low-cost and yet highly effective locking device, i.e. a block against retraction of the roll bar after a deployment due to an accident, the invention provides a detent pawl arrangement articulated in a pivoting manner and affixed to the vehicle and under spring tension in the locking direction by a retaining spring, with two extensions extending at least across the width of the rollover body, that in the protective position of the rollover body can be pivoted into direct active contact with corresponding supports on the rollover body.

### BACKGROUND OF THE INVENTION

1. Field of the Invention

The invention relates to a rollover system for motor vehicles with a rollover body held guided in a holder affixed to the vehicle, a drive for sensor-controlled deployment of the rollover body from a resting position to a protection position, and a locking device for the rollover body deployed in a protective position.

2. Description of Related Art

Such rollover protection systems are for protecting passengers in motor vehicles without a protective roof, typically in convertibles or roadsters, so that the vehicle rolls over the deployed rollover body, which creates a survival area for the passengers in a rollover.

It is known to provide a roll bar that extends the entire width of the motor vehicle and is designed as part of the body. In this solution, the increased air resistance and vehicle noise generated is perceived as disadvantageous, apart from the impairment of the vehicle's appearance.

It is also known to assign each vehicle seat a non-height-adjustable roll bar permanently installed in the passenger compartment, i.e. a rigid, U-shaped roll bar. This solution is typically used for roadsters to underscore the sporty appearance.

Widespread in convertibles are design solutions where the rollover body is normally retracted and, in case of a hazard, i.e. in case of an imminent rollover, the rollover body quickly deploys into a protective position to prevent the passengers from being crushed by the rolling vehicle.

These so-called “active” rollover protection systems typically have a U-shaped roll bar guided in a guide body permanently attached to the vehicle or a rollover body formed out of a shaped body, and the guide body is affixed in a cassette housing that has side parts and a floor part. This roll bar or rollover body is normally held by a holding device in a lower, resting position under spring tension from at least one drive pressure spring, and in a rollover, the roll bar can be moved into an upper, protective position in response to a sensor by means of the spring force of the drive pressure spring when the holding device releases, and a locking device, the retraction lock, having engaging teeth prevents the roll bar from being pressed back inside. Each motor vehicle seat is typically assigned one cassette. Such a cassette construction of an active rollover protection system with a U-shaped roll bar is disclosed, for example, in DE 100 40 649 C1.

In addition to cassette designs, active rollover protection systems are also known that use a rear wall principle and have a rear wall assembly as described, for example, in DE 103 44 446 B3. This principle has a frame construction, positioned between the rear passenger compartment and the trunk, consisting on the one hand of a shaped cross member permanently affixed to the body and extending across the inner width of the vehicle that has guiding means for two adjacent, U-shaped roll bars, and consisting on the other hand of shaped member elements extending vertically downward with a floor part for receiving the usual components of the extendable rollover protection system such as the trigger magnet for the sensor-controlled triggering of the extension movement of the roll bars, and the drive pressure springs.

Both the cassette designs and cross member designs have been introduced to the market and are used in many embodiments adapted to the respective vehicle type.

In all these active rollover protection systems, in which the invention too can be used, it is necessary to provide a locking device activatable in case of hazard, the retraction lock, that in the deployed state of the rollover body prevents it from being pushed back into the cassette or into the rear wall assembly, with loss of the survival area, due to the forces generated in a rollover. This locking device therefore performs an essential safety function.

Numerous constructions for this locking device have become known in the prior art. They are predominantly based on the engaging interaction of two mutually complementary tooth elements. Thus the cited DE 100 40 649 C1 discloses a locking device consisting, first, of a latch arbor which is fastened to a traverse that links both arm ends of the corresponding U-shaped roll bar and that moves out with it, and second, of a detent pawl that is articulated in a pivoting manner in the massive guide block affixed to the vehicle that guides the bar arms, in such a way that it can be caused to lockingly engage with the latch arbor. Solutions are also known in the prior art in which the two locking components are positioned in the opposite manner, i.e. with the latch arbor on the guide block affixed to the vehicle and the detent pawl on the traverse that moves out with the rollover body. Solutions with interlocked strips are also known in the prior art.

In these known solutions, aside from the necessary component and assembly expense, the locking device is stressed by the rollover forces largely on one side, i.e. asymmetrically.

The enormous cost pressure in the automobile industry requires ever lower cost solutions from supplier companies. So it is too with respect to rollover protection systems.

Therefore the underlying task of the invention is to create a rollover protection system with a very simple, low-cost locking device preventing the retraction of the rollover body after deployment due to an accident, which nonetheless ensures very secure locking of the rollover body.

### BRIEF SUMMARY OF THE INVENTION

The solution of the aforementioned problem succeeds in a rollover protection system for motor vehicles, with a rollover body held guided in a holder affixed to the vehicle, a drive for sensor-controlled deployment of the rollover body from a resting position to a protective position, and a locking device for the rollover body deployed in a protective position, according to the invention, in that a detent pawl arrangement articulated in a pivoting manner and affixed to the vehicle and under spring tension in the locking direction by a retaining spring is provided, with two extensions extending at least across the width of the rollover body, that in the protective position of the roll bar can be pivoted into direct active contact with corresponding supports on the rollover body.

Therefore in the inventive locking device, the locking action occurs directly on the rollover body, in particular in the case of a U-shaped roll bar on its two bar arms. Because of the length of the pawl arrangement extending across the width of the rollover body and because of the spaced simultaneous engagement of the extensions (which can also be described as arm extensions) with the rollover body, in particular with its bar arms, the locking device is stressed relatively evenly by the centrally impacting rollover forces. In addition, only one pawl arrangement is required for the locking action, which reduces the component and assembly expense—and thus the cost—as well. In addition, in the case of a U-shaped roll bar, the traverse with the latch arbor can be dispensed with. The holder of the roll bar affixed to the vehicle, the so-called massively designed guide block, can also be designed much more simply, since its only task now is to guide the bar arms. Thus it would be conceivable to construct the guide block using simple tubes with welded-on flanges.

The forces arising in the locking device during a rollover are absorbed largely directly into the rollover body, e.g. into the bar arms, by means of a targeted force conveyance.

A particularly great advantage results to this extent when the corresponding supports on the rollover body are formed by its lower front-facing ends, i.e. the blocking e.g. in a U-shaped roll bar can occur directly under the free ends of the arm tubes. In this way, no separate supports, i.e. bearings, must be designed on the rollover body.

However, it is also conceivable to provide openings as supports on the rollover body, e.g. on the inner side of the bar arms, which the extensions of the pawl arrangement snap into. These openings can be partially reinforced, or even weakened, if for example a deforming energy reduction is desired as an “overstress protection” for the system as a whole, in which the extensions of the detent pawl arrangement cut in a deforming manner into the wall of the rollover body, e.g. into the tube walls of the arm tubes.

Various possibilities are available for the constructive design of the two-armed detent pawl arrangement. An initial, very simple cost-saving alternative consists of providing only a single rotary detent pawl with two extensions positioned aligned in one piece. The articulation, affixed to the vehicle, of the two-armed rotary detent pawl can be done concentrically, or also eccentrically, as explained in greater detail in the description of the figures.

By means of eccentric articulation, the differential stressing of the rollover body in a rollover can be taken into account. Since, for example in a U-shaped roll bar, the outer arm tube vis-à-vis the vehicle is generally under greater stress, through a corresponding asymmetric articulation a compensating effect can be achieved in terms of the reciprocal action with the other arm tube.

Meanwhile, if the force conveyed to the inner bar arm is greater than to the outer bar arm, in principle corresponding stops on the arm tubes can prevent the more weakly stressed arm tube from being pushed upward due to leverage.

The supports or bearings can be designed at the same height or at different heights on the rollover body. For U-shaped roll bars with support on the free end face of the bar arms, the arm tubes can therefore be of the same length or different lengths.

The single rotary detent pawl can be configured geometrically in different ways. In the case of supports at different heights, the rotary detent pawl is preferably designed in an S-shaped pivoted or trestle-angle-like manner, so that its ends can be held horizontally by the supports and provide strong force conveyance into the vehicle structure. In the case of supports at the same height, the rotary detent pawl can be designed with its locking extensions extending preferably linearly like a balance beam.

In the case of supports at different heights, the single rotary detent pawl comes to rest against the rollover body in a diagonal position when the deployed protective position is attained. A rotary detent pawl arranged in such a way is intended to come more and more into a horizontal position with increasing load, so that a strengthening effect results with respect to the achievable locking force. In the case of U-shaped roll bars, for example, depending on the design of the supports in the bar arm tubes, either a greater jamming of the rotary detent pawl between the bar arm tubes or an enlarged bearing or supporting surface on the front face under the free ends of the bar arm tubes will be the result.

According to a further embodiment of the invention, the detent pawl arrangement articulated to the vehicle body can be designed to have multiple parts, in particular to comprise two, two-armed rotary detent pawls that can be spread apart from one another. In this case, then, the two rotary detent pawls can be pivoted independently of one another to support the rollover body or its arm tubes.

Because of the pre-tensing retaining spring, the ends of the extensions of the detent pawl arrangement butt against the corresponding guides on the rollover body, e.g. against the inner surfaces of the arm tubes in the case of a U-shaped roll bar, with a certain frictional force. In this way, it is advantageous in the case of a pyrotechnic drive system that no separate holding mechanism is required to hold down the rollover body. The ends of the arm tubes rest in a foam cushion at the base, in order to avoid clattering or vibrational noises while driving. To increase the holding force, the system can also be held with positive locking.

In the case of an arrangement with arm tubes of different lengths, the arrangement can be made in such a way that a spring drive with only one rotary helical spring in the shorter arm tube is provided as a drive for deploying the roll bar, with the spring being guided by a spring guide rod and resting at the base in an impression in a foam cushion.

Further embodiments of the invention are cited in the subclaims and also result from the description of the figures.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. The invention will be further explained with reference to two exemplary embodiments of the inventive locking device shown in the drawings. For the purpose of illustrating the invention, there is shown in the drawings embodiments which are presently preferred. It should be understood, however, that the invention is not limited to the precise arrangements and instrumentalities shown. In the drawings:

FIG. 1 shows a schematic front view of a rollover protection system with a roll bar that has an initial embodiment of the inventive locking device in the form of a detent pawl arrangement with a one-piece two-armed rotary detent pawl extending linearly, with Figure Part A showing the stored resting position and Figure Part B showing the roll bar deployed in the protective position,

FIG. 2 shows a view corresponding to FIG. 1 with a second embodiment of the detent pawl arrangement comprised of two angled detent pawls that can be pivoted against one another and that can both be caused to engage with a stop affixed to the vehicle, and

FIG. 3 shows a view corresponding to FIG. 1 with an enhancement of the holding force with positive locking.

### DETAILED DESCRIPTION OF THE INVENTION

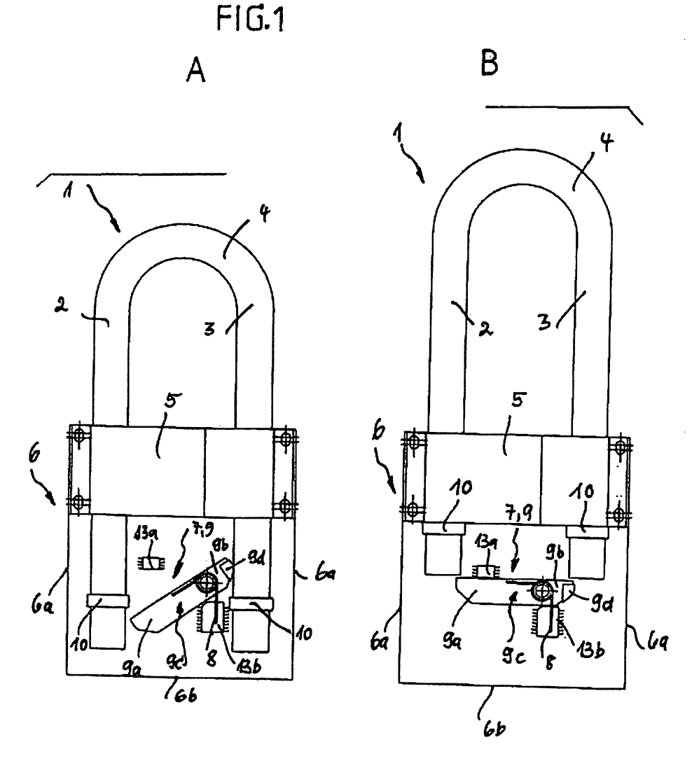

FIG. 1, in its two parts A, B, shows schematic front views of an initial variant of an active rollover protection system for motor vehicles furnished with the inventive locking device. This system has a U-shaped roll bar 1 as the rollover body, which has two tube shaped bar arms or arm tubes 2,3 that are connected to one another by means of a cross yoke in the form of a rounded bar head 4. The bar arms or arm tubes 2, 3 are held and guided in a holder 5 affixed to the vehicle, the so-called guide block, which is part of a cassette-like guide housing 6 with side parts 6a and a base part 6b.

Such rollover protection systems are known in a wide variety of embodiments, e.g. from DE 100 40 649 C2 cited at the start, and therefore do not need to be described in detail here. Nor is it necessary to describe the drive for sensor-controlled deployment of the roll bar from a resting position (Figure Part A) into a protective position (Figure Part B), whereby the drive can typically be formed by a spring drive under spring tension or by a pyrotechnic drive set, or to describe the holding device for holding down the roll bar in the resting position. The design and arrangement of these components follows known principles.

In order to ensure that the deployed roll bar cannot be pressed back into the cassette-like housing in a rollover due to the forces arising thereby, actively deployable protection systems have a locking device, the so-called retraction lock. FIG. 1 shows an initial variant of a very simple, low-cost locking device 7.

As a locking device, in principle a detent pawl arrangement 9 is provided, articulated to the vehicle in a pivoting manner below bar arms 2, 3 and under spring tension from a retaining spring 8 in the direction of locking, with two blocking arms 9a, 9b that extend at least across the width of the roll bar. When the roll bar is stored in the resting position (FIG. 1 Part A), this detent pawl arrangement 9 is pivoted such that the roll bar with its two bar arms 2, 3 is able to slide out easily with little friction. In the deployed state of the wall bar, the detent pawl arrangement is pivoted due to the retaining spring 8 under spring tension in such a way that the locking end sections of the two extensions 9a, 9b are in direct locking engaging contact with corresponding supports or bearings on the roll bar in a pivoting manner, so that this causes a stable and secure blockage to be achieved against the roll bar being pressed back.

In the case of the variant shown in FIG. 1, the two-armed detent pawl arrangement 9 is formed by a single, rigid, balance-beam-like rotary detent pawl 9c with two aligned, one-piece rigidly positioned blocking extensions 9a, 9b, that is articulated eccentrically so that the extensions 9a, 9b are formed unequally, i.e. asymmetrically. The rotary detent pawl 9c is under spring tension in the direction of support, i.e. in the blocking direction, from a retaining spring 8 which is designed here as a spiral spring.

The supports or bearings on the bar arms are formed in the case of the embodiment according to FIG. 1 by the front faces of the free ends of the tube-shaped bar arms 2, 3. In the deployed state, the ends of the blocking extensions 9a, 9b lie under the front face ends of the bar arms and support them in case of stressing.

Through an asymmetrical design of the single rotary detent pawl, it is possible to allow it to rest only on one side against one of the two bar arms in a sliding manner when the roll bar is stored. Preferably the corresponding front face end 9d is optimized in a sliding manner in terms of shape or material.

The opposite front face end of the rotary detent pawl is not touching its corresponding bar arm during the deployment process and so it does not generate any friction. This ensures a very frictionless deployment of the roll bar.

To limit the deployment lift of the roll bar, a solid stop 10 is affixed to both bar arms. In addition to blocking the path, this stop also provides additional support functions in conjunction with rotary detent pawl 9c.

In a vehicle rollover, it cannot be assumed, namely, that the supporting forces will always be conveyed symmetrically into both bar arms of the roll bar. If the forces do not impact the roll bars symmetrically and therefore if different forces are generated in the bar arms, that will lead to the generation of different torques in the blocking extensions of the supporting rotary detent pawl.

But this will only happen if bar head 4 is deformed due to the stress and arm tubes 2, 3 shift relative to one another in the axial direction. If the stress is very different, so that bar head 4 is deformed, and if the greater stress impacts arm tube 2, which is supported by longer extension 9a of the rotary detent pawl, then a torque will be generated in shorter blocking extension 9b of the rotary detent pawl in the direction toward “open” (greater force X longer lever arm=greater torque). The arm tube with the greater torque would thereby, via the balance-beam-like two-armed rotary detent pawl, generate a greater reaction force which is directed upwards in the opposite arm tube 3. This force will be absorbed by stop 10 on the parallel arm tube, which comes to rest against the guide housing underside (floor part 6b), thereby preventing the “reactive displacement” of the more highly stressed bar arm. Two additional stops 13a, 13b affixed to the vehicle are used to fix the horizontal position of linear rotary detent pawl 9c.

Since, in practice, typically in a rollover, the arm tubes toward the outside of the vehicle, in this case arm tube 3, are stressed, the short lever arm 9b of rotary detent pawl 9c is assigned to this arm tube 3 to minimize the “reactive displacement.”

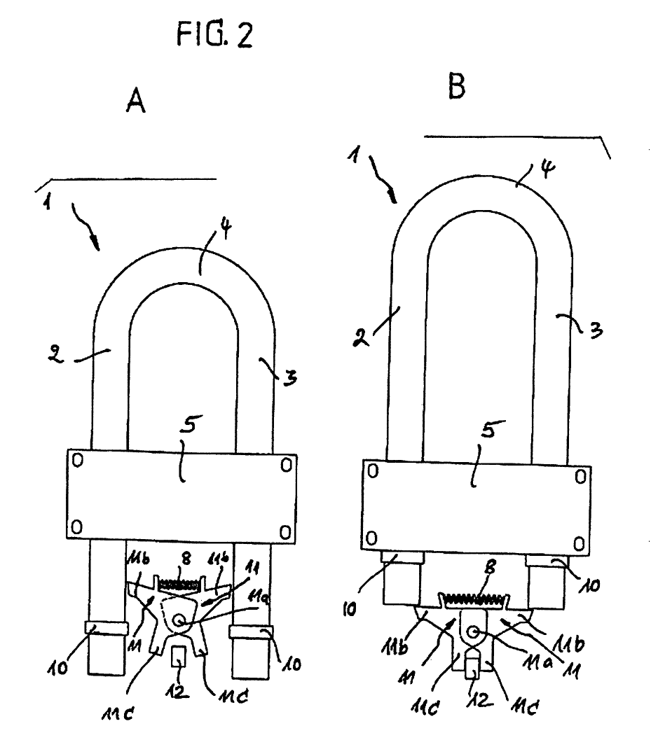

FIG. 2, in its two parts A and B analogous to FIG. 1, shows another variant of the inventive locking device. In this variant, detent pawl arrangement 9 is not formed by a two-armed one-piece balance-beam-like rotary detent pawl as in the case of FIG. 1, but by two rotary detent pawls 11 that can be pivoted against one another and are articulated symmetrically at the same pivot point 11a.

In the variant according to FIG. 2, the detent pawls each have two angled blocking extensions 11b and 11c. Each of upper extensions 11b, under spring tension in the blocking direction from retaining spring 8, which in this variant is designed as a helical spring, touches the inner side of bar arms 2, 3 in a sliding manner (Figure Part A), while the other lower arm 11c after attaining the supporting position (Figure Part B) comes into engaging contact with a shared stop 12 attached to the vehicle that prevents full rotation. Retaining spring 8 spreads rotary detent pawls 11 against one another in such a way that upper extensions 11 b come under the front faces of bar arms 2, 3 and prevent a downward motion of the roll bar.

In case of stress, two rotary detent pawls 11 with their lower extensions 11c butt against shared fixed stop 12.

Therefore, the load moments largely cancel each other out. Thus reactive moments as in the case of the embodiment of FIG. 1 are not generated in the variant of FIG. 2. Stops 10 designed on bar arms 2, 3 therefore serve only to limit lift in the deployment of the roll bar.

Instead of a shared fixed stop 12, two stops affixed to the vehicle at a distance from one another can also be provided, which enter into engaged contact with the corresponding complementarily designed lower blocking extension 11c of two rotary detent pawls 11.

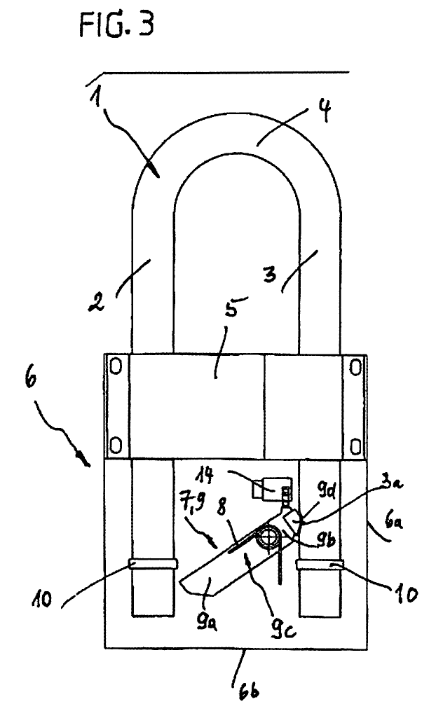

FIG. 3 shows a variant of the embodiment of FIG. 1 in the held basic state (Figure Part A), with stops 13a, 13b omitted. To increase the holding force, a form-fitting holder is provided between linear rotary detent pawl 9c and roll bar 1. For this purpose, as shown, a bar arm 3 with a tangential impression 3a is provided into which blocking arm 9b of linear rotary detent pawl 9c engages with its sliding extension end 9d in a form-fitting manner.

To release the form-fitting connection, a sensor-controlled actuator 14 is provided, e.g. a pyrotechnic actuator with a piston-retracting or -extending function, that is shown symbolically in FIG. 3 in terms of its structure and positioning. The actuator, triggered in case of a crash, gives rotary detent pawl 9c the ability to pivot around a small angle, so that roll bar 1 under spring tension is released and can move out.

### List of Reference Signs

1 Roll bar

2, 3 Bar arms (arm tubes)

3a Tangential impression

4 Bar head

5 Holder affixed to the vehicle (guide block)

6 Cassette-like guide housing

6a Side parts

6b Floor part

7 Locking device

8 Retaining spring

9 Detent pawl arrangement

9a, 9b Blocking extensions

9c Linear rotary detent pawl

9d Sliding extension end

10 Limit stop

11 Angled rotary detent pawls

11a Pivot point

11b, 11c Angled extensions

12 Stop affixed to the vehicle

13a,13b Stops affixed to the body

14 Sensor-controlled actuator

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A rollover protection system for motor vehicles, with a rollover body held guided in a holder affixed to a vehicle, a drive for sensor-controlled deployment of the rollover body from a resting position to a protective position, and a locking device for the rollover body deployed in a protective position, comprising a detent pawl arrangement which is articulated in a pivoting manner and affixed to the vehicle, and under spring tension in a locking direction by a retaining spring, with two extensions extending at least across a width of the rollover body, that in the protective position of the rollover body can be pivoted into direct active contact with corresponding supports on the rollover body.

2. The rollover protection system of claim 1, wherein corresponding supports on the rollover body are formed by its front-facing lower ends.

3. The rollover protection system of claim 1, wherein corresponding supports on the rollover body are formed by catch openings for ends of the extensions of the detent pawl arrangement.

4. The rollover protection system of claim 1, wherein a two-armed detent pawl arrangement is formed by a single rotary detent pawl with two extensions positioned aligned in one piece.

5. The rollover protection system of claim 4, wherein the rotary detent pawl is articulated to the vehicle concentrically or eccentrically.

6. The rollover protection system of claim 4, wherein the rotary detent pawl is designed in an S-shaped curved or balance-beam-like linearly extending manner.

7. The rollover protection system of claim 1, wherein the detent pawl arrangement is formed by least two rotary detent pawls that can be spread against one another.

8. The rollover protection system of claim 7, wherein each of the two rotary detent pawls has an angled upper arm for blocking, engaging interaction with the corresponding support on the roll bar and an angled lower arm for blocking, engaging interaction with a stop affixed to the vehicle.

9. The rollover protection system of claim 8, wherein a shared stop affixed to the vehicle is provided for both angled lower arms.

10. The rollover protection system of claim 1, wherein supports are designed at the same height or at different heights on the rollover body.

11. The rollover protection system of claim 10 with a U-shaped rollbar comprised of a bar head with two parallel bar arm tubes, wherein the arm tubes are designed to be of equal length or of different lengths.

12. The rollover protection system of claim 1, wherein a sensor-controlled, releasable, form-fitting connection between at least one extension end of the detent pawl arrangement and a complementary holder in the rollover body is provided for holding the rollover body in the resting position.

13. The rollover protection system of claim 12, wherein an actuator that can be activated in case of a crash is provided for the sensor-controlled release of the form-fitting connection.
